(19) United States
(12) Patent Application Publication
(10) Pub. No.: US 2026/0278723 A1
(43) Pub. Date: Sep. 17, 2026

(54) SYSTEMS AND METHODS FOR URBAN UNDERGROUND SPACE EMERGENCY WARNING BASED ON INTERNET OF THINGS (IOT) LARGE MODELS

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Guobin LUO, Chengdu (CN); Xing SHU, Chengdu (CN)

(73) Assignee: CHENGDU QINCHUAN IOT TECHNOLOGY CO., LTD., Chengdu, Sichuan (CN)

(21) Appl. No.: 19/669,931

(22) Filed: May 6, 2026

(30) Foreign Application Priority Data
Apr. 17, 2026 (CN) 202610508679.8

(51) Int. Cl. G06Q 50/26; G05D 9/12

(52) U.S. Cl. CPC G06Q 50/265; G05D 9/12

(57) ABSTRACT

A system and a method for urban underground space emergency warning based on an IoT large model are provided. The system includes an emergency supervision management platform configured to: determine a maximum drainage flow rate based on a working parameter of a current drainage device; determine a first water level height and a first water level change of a first drainage structure; obtain a passenger density and passenger flow information of each sub-region in an underground space; based on the first water level change and the maximum drainage flow rate, predict a water accumulation probability of each sub-region; determining a control time interval when the water accumulation probability of at least one sub-region exceeds a probability threshold; adjusting an entrance gate of the underground space to a prohibited entry state at a control time point; and controlling the drainage device to perform drainage at a maximum power.

### CROSS-REFERENCE TO RELATED APPLICATIONS

This application claims priority to Chinese Patent Application No. 202610508679.8, filed on Apr. 17, 2026, the entire contents of which are hereby incorporated by reference.

### TECHNICAL FIELD

The present disclosure relates to the technical field of urban public safety and emergency management, and specifically relates to a system and a method for urban underground space emergency warning based on an Internet of Things (IoT) large model.

### BACKGROUND

With the acceleration of urbanization, urban underground spaces, especially subway stations, underground transportation hubs, and underground commercial streets, have become an essential component of modern urban functionality. These underground facilities provide significant convenience for alleviating ground traffic pressure and expanding urban development space. However, the enclosed and complex environment poses substantial safety hazards for underground spaces. Particularly under extreme weather conditions such as heavy rain, risks of waterlogging due to rainwater backflow may overlap with risks of large crowds gathering in underground spaces, potentially leading to severe mass casualty incidents.

Therefore, it is desirable to provide a system and a method for urban underground space emergency warning based on an Internet of Things (IoT) large model. The system and the method can, under dynamically changing conditions of water accumulation and personnel distribution within complex underground spaces, provide an emergency warning plan for personnel evacuation and drainage operations, thereby improving evacuation efficiency and safety.

### SUMMARY

One or more embodiments of the present disclosure provide a system for urban underground space emergency warning based on an Internet of Things (IoT) large model, comprising an emergency supervision management platform. The emergency supervision management platform is configured to: based on a working parameter of a current drainage device, determine a maximum drainage flow rate of the current drainage device; based on a water level measurement device, determine a first water level height and a first water level change of a first drainage structure; based on a sensing device, determine a personnel density and personnel flow information for each of one or more sub-regions within an underground space; based on the first water level change and the maximum drainage flow rate, determine an accumulated water probability for each of the one or more sub-regions within the underground space; and in response to the accumulated water probability of at least one sub-region being greater than a probability threshold, determine a control time interval based on the personnel density and the personnel flow information, adjust an entrance gate of the underground space to a prohibited entry state at a control time point, and control the current drainage device to perform drainage at a maximum power, the control time point being determined based on the control time interval.

One or more embodiments of the present disclosure provide a method for urban underground space emergency warning based on an Internet of Things (IoT) large model. The method is executed by an emergency supervision management platform in a system for urban underground space emergency warning based on the IoT large model. The method comprises: based on a working parameter of a current drainage device, determining a maximum drainage flow rate of the current drainage device; based on a water level measurement device, determining a first water level height and a first water level change of a first drainage structure; based on a sensing device, determining a personnel density and personnel flow information for each of one or more sub-regions within an underground space; based on the first water level change and the maximum drainage flow rate, determining an accumulated water probability for each of the one or more sub-regions within the underground space; and in response to the accumulated water probability of at least one sub-region being greater than a probability threshold, determining a control time interval based on the personnel density and the personnel flow information, adjusting an entrance gate of the underground space to a prohibited entry state at a control time point, and controlling the current drainage device to perform drainage at a maximum power, the control time point being determined based on the control time interval.

One or more embodiments of the present disclosure provide a non-transitory computer-readable storage medium, storing a computer instruction, wherein when a computer reads the computer instruction in the storage medium, the computer executes the method for urban underground space emergency warning based on an Internet of Things (IoT) large model described in one or more embodiments of the present disclosure.

### BRIEF DESCRIPTION OF THE DRAWINGS

The present disclosure will be further elucidated by way of exemplary embodiments, which are described in detail with reference to the accompanying drawings. These embodiments are not limiting. In these embodiments, the same reference numerals denote the same structures, wherein:

FIG. 1 is a structural diagram illustrating a system for urban underground space emergency warning based on an Internet of Things (IoT) large model according to some embodiments of the present disclosure;

FIG. 2 is a flowchart illustrating an exemplary process of a method for urban underground space emergency warning based on an IoT large model according to some embodiments of the present disclosure;

FIG. 3 is an exemplary schematic diagram illustrating the determination of a control time interval according to some embodiments of the present disclosure;

FIG. 4 is a schematic flowchart illustrating broadcasting an evacuation route according to some embodiments of the present disclosure; and

FIG. 5 is an exemplary flowchart illustrating adjusting an evacuation route according to some embodiments of the present disclosure.

### DETAILED DESCRIPTION

To more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose. The term “and/or”, as used herein, is merely a way of describing the associative relationship of an associated object, indicating that three relationships may exist, e.g., A and/or B, which may be represented as: A alone, both A and B, and B alone.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Furthermore, if the description of the embodiments in the present disclosure involves descriptions such as “first” and “second,” then these descriptions are for descriptive purposes only and are not to be construed as indicating or implying relative importance or implicitly specifying the quantity of the indicated technical features. Thus, features defined by “first” or “second” may explicitly or implicitly include at least one such feature.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

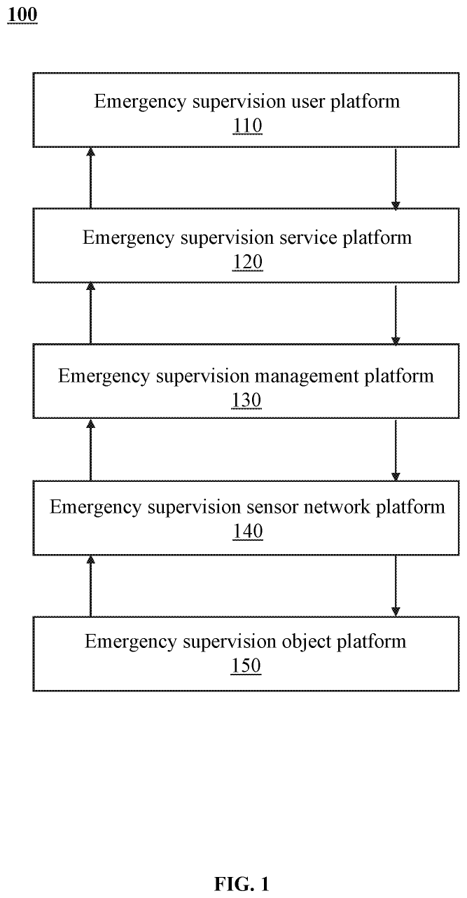

FIG. 1 is a structural diagram of a system for urban underground space emergency warning based on an Internet of Things (IoT) large model according to some embodiments of the present disclosure.

In some embodiments, as shown in FIG. 1, a system 100 for urban underground space emergency warning based on an IoT large model (also referred to as the underground space emergency warning system) includes an emergency supervision user platform 110, an emergency supervision service platform 120, an emergency supervision management platform 130, an emergency supervision sensor network platform 140, and an emergency supervision object platform 150, which are sequentially connected. One or more platforms within the system 100 may exchange information and/or data via a network. In some embodiments, the network may be any one or more of a wired network or a wireless network.

The emergency supervision user platform 110 refers to an interactive platform providing emergency service operations for users, including user terminals. For example, the user terminals include devices with input and/or output functions, such as computers. The users may include system operators or personnel to be evacuated within the underground space, or the like.

The underground space refers to a space below a ground surface. For example, the underground space may include a subway station, an underground bus station, an underground commercial street, an underground parking lot, etc.

The emergency supervision service platform 120 refers to an interactive service platform for receiving and transmitting data, including a server, a gateway, a router, or the like.

In some embodiments, the emergency supervision service platform 120 interacts upward with the emergency supervision user platform 110 and interacts downward with the emergency supervision management platform 130.

The emergency supervision management platform 130 refers to a comprehensive platform for processing and managing emergency supervision data.

In some embodiments, the emergency supervision management platform 130 may include a processor and/or a server, a data center, etc. The data center is configured with a storage device.

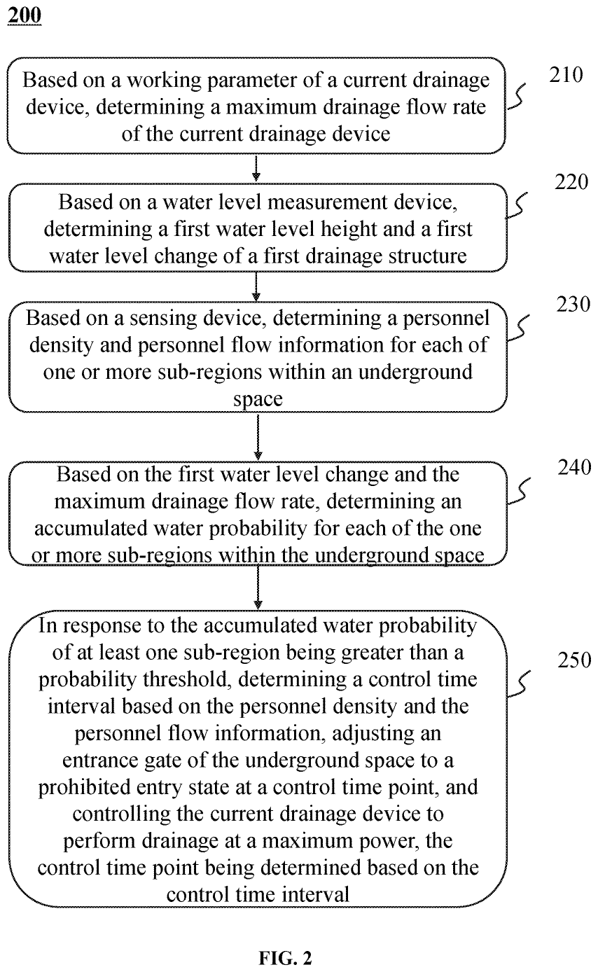

In some embodiments, the emergency supervision management platform 130 may be configured to execute a method for urban underground space emergency warning based on an IoT large model. More details regarding the method may be found in the related description of FIG. 2.

The emergency supervision sensor network platform 140 refers to a management platform for transmitting sensor data or information related to emergency supervision, including a communication transmission network and a routing device.

In some embodiments, the emergency supervision sensor network platform 140 interacts upward with the emergency supervision management platform 130 and interacts downward with the emergency supervision object platform 150.

The emergency supervision object platform 150 refers to a functional platform for collecting data or executing instructions.

In some embodiments, the emergency supervision object platform 150 may include various devices, such as, a drainage device, a water level measurement device, a sensing device, a broadcast device, or the like.

The drainage device refers to a device possessing drainage functions, for example, a drainage pump, etc. In some embodiments, the drainage device is configured to remove accumulated water within the underground space, including a current drainage device and a backup drainage device. Details regarding the current and backup drainage device may be found in the subsequent related description.

Further descriptions regarding the water level measurement device, the sensing device, and the broadcast device may be found in the subsequent related description.

In some embodiments of the present disclosure, the system for urban underground space emergency warning based on an IoT large model can establish a closed-loop information operation among various functional platforms, operating in a coordinated and regular manner. By determining and updating an evacuation path, the system aims to enhance emergency evacuation efficiency and safety.

FIG. 2 is a flowchart illustrating an exemplary process of a method for urban underground space emergency warning based on an IoT large model according to some embodiments of the present disclosure. As shown in FIG. 2, a process 200 includes the following steps. In some embodiments, the process 200 may be executed by the emergency supervision management platform within the system 100.

Step 210, based on a working parameter of a current drainage device, determining a maximum drainage flow rate of the current drainage device.

The current drainage device refers to a drainage device activated when drainage operations are required. Further details regarding the drainage device may be found in the description related to FIG. 1.

The working parameter refers to one or more operating parameters related to the drainage operation. For example, the working parameter of the current drainage device may include a count of current drainage devices, as well as a rated power, an efficiency, and a minimum working head of each current drainage device, or the like.

In some embodiments, the emergency supervision management platform may determine the counr of current drainage devices based on an activation status of each current drainage device, and determine parameters such as the rated power, the efficiency, and the minimum working head of each current drainage device based on factory specifications of the current drainage device.

The maximum drainage flow rate refers to a maximum volume of water that all current drainage devices can discharge per unit of time.

In some embodiments, the emergency supervision management platform may determine the maximum drainage flow rate of the current drainage device in various ways based on the working parameter. For example, the emergency supervision management platform may determine the maximum drainage flow rate based on the working parameter of the current drainage device according to a preset flow calculation formula. By way of example, the preset flow calculation formula (1) may be expressed as:

$${q}_{max} = \frac{P \times η}{ρ \times g \times H} , \qquad ( 1 )$$

where, qₘₐₓ denotes the maximum drainage flow rate, measured in cubic meters per hour (m³/h); P denotes the rated power of the current drainage device, measured in kilowatts (kW); η denotes the efficiency of the current drainage device; H denotes the minimum working head of the current drainage device, measured in meters (m); ρ denotes a density of water; and g is the acceleration due to gravity.

Step 220, based on a water level measurement device, determining a first water level height and a first water level change of a first drainage structure.

The water level measurement device refers to a device used for monitoring water level information. For example, the water level measurement device may include a water level sensor. The water level measurement device may be deployed within the first drainage structure.

The first drainage structure refers to one or more construction facilities located within the underground space, designed for water collection and drainage. For example, the first drainage structure may include sumps, open drainage ditches, and drainage pipes. One or more sumps are mechanically connected to multiple open drainage ditches and multiple drainage pipes to collect accumulated water within the underground space and discharge the accumulated water via the drainage device. Each sump has a corresponding drainage device.

For related descriptions of the underground space, please refer to the relevant description of FIG. 1 in the present disclosure.

The first water level height refers to a water level height of the first drainage structure at a current time. In some embodiments, the water level measurement device deployed in the first drainage structure may directly monitor and obtain the first water level height, and transmit the first water level height to the emergency supervision management platform via the emergency supervision sensor network platform.

The first water level change refers to a rate of change of the first water level height of the first drainage structure at the current time. The first water level change can reflect a speed at which the first water level height of the first drainage structure is rising or falling at the current time. The first water level change may be expressed as an amount of change in the first water level height per unit time, where a positive value indicates that the first water level change is rising first water level height and a negative value indicates that the first water level change is falling.

In some embodiments, the emergency supervision management platform may perform curve fitting on the first water level heights corresponding to multiple time points within a current period and take a slope of a tangent line at the current time as the first water level change at the current time. The current period refers to a preset time period before the current time, which may be predefined by technical personnel.

Step 230, based on a sensing device, determining a personnel density and personnel flow information for each of one or more sub-regions within the underground space.

The sensing device refers to a device capable of collecting crowd information. Exemplary sensing devices may include a thermal imaging camera, a video analytics camera, 3D stereo vision camera, an infrared counter, etc.

Sensing devices may be deployed in various sub-regions within the underground space. For example, sensing devices may be installed at entrances/exits and other locations (e.g., platforms, passageways) within the underground space.

A sub-region refers to a partial region within the underground space. The sub-regions may be pre-defined by technical personnel. For example, the sub-regions may be divided based on functional areas such as entrance/exit zones, platform zones, passageway zones, etc. An area of each sub-region is pre-stored in the emergency supervision management platform.

The personnel density refers to the count of personnel per unit area.

The personnel flow information refers to relevant information reflecting the movement of personnel. For example, the personnel flow information may include a personnel movement direction, a personnel density change rate, etc.

In some embodiments, the emergency supervision management platform may obtain the count of personnel in a sub-region based on the sensing device, determine a ratio of the count of personnel in the sub-region to the area of the sub-region as the personnel density of the sub-region. The emergency supervision management platform may further determine the personnel flow information based on the personnel densities of the one or more sub-regions. For example, if the personnel density of a first sub-region increases while the personnel density of an adjacent second sub-region decreases, the personnel movement direction is from the second sub-region to the first sub-region. As another example, the emergency supervision management platform may determine a ratio of a change in personnel density of a sub-region during the aforementioned current period to a duration of the current period as the personnel density change rate, where a positive value indicates an increase in the personnel density and a negative value indicates a decrease in the personnel density.

Step 240, based on the first water level change and the maximum drainage flow rate, determining an accumulated water probability for each of the one or more sub-regions within the underground space.

The water accumulation probability refers to the likelihood of water accumulation occurring in a sub-region of the underground space. In some embodiments, the water accumulation probability may be represented by 0 or 1, where 0 indicates that water accumulation will not occur, and 1 indicates that water accumulation will occur. In some embodiments, the water accumulation probability may also be represented by a value between 0% and 100%, where a higher value indicates a greater probability of water accumulation.

In some embodiments, the emergency supervision management platform may determine the water accumulation probability for each sub-region within the underground space in various ways based on the first water level change and the maximum drainage flow rate.

For example, a sump pit is equipped with four current drainage devices to discharge accumulated water from the pit. The emergency supervision management platform may calculate a product of the first water level change of the sump pit and a bottom area of the sump pit. If the product is less than the maximum drainage flow rate of the four current drainage devices in the sump pit, it indicates that a water accumulation rate in the sump pit is lower than a drainage rate of the current drainage devices, meaning the drainage capacity is sufficient to handle the current water accumulation issue. The emergency supervision management platform may then determine that the water accumulation probabilities for sub-regions adjacent to th sump pit are 0. Conversely, the water accumulation probabilities for the sub-regions adjacent to the sump pit are 1. The sub-regions adjacent to a sump pit include a sub-region where the sump pit itself is located, as well as one or more other sub-regions whose geographical boundaries are connected to the sub-region where the sump pit is located.

In some embodiments, the emergency supervision management platform may determine the water accumulation probability for sub-regions adjacent to a sump pit using formula (2), which may be expressed as follows:

$${y}_{1} = \frac{{v}_{1} * S}{{V}_{max}} * 100 \% , \qquad ( 2 )$$

wherein, y₁ denotes the water accumulation probability for each sub-region adjacent to the sump pit (the water accumulation probability for each adjacent sub-region is considered equal), v₁ denotes the first water level change, S denotes the bottom area of the sump pit, and Vₘₐₓ denotes the maximum drainage flow rate of all current drainage devices within the sump pit.

As another example, if the first water level height of an open drainage ditch or a drainage pipe is less than a preset water level threshold, the emergency supervision management platform may determine that the water accumulation probabilities for sub-regions adjacent to the open drainage ditch or the drainage pipe are 0. Correspondingly, if the first water level height of an open drainage ditch or a drainage pipe is greater than the preset water level threshold, the emergency supervision management platform may determine that the water accumulation probabilities for sub-regions adjacent to the open drainage ditch or the drainage pipe are not 0. Moreover, the greater the first water level change of the open drainage ditch or the drainage pipe, the higher the water accumulation probabilities for the corresponding adjacent sub-regions (closer to 100%). The preset water level threshold may be predefined by technical personnel. The sub-regions adjacent to an open drainage ditch include a sub-region where the ditch itself is located, as well as one or more other sub-regions whose geographical boundaries are connected to the sub-region where the ditch is located. The same principle applies to sub-regions adjacent to a drainage pipe.

In some embodiments, the emergency supervision management platform may determine a second water level height and a second water level change of a second drainage structure based on a water level measurement device; and determine the water accumulation probability for each sub-region within the underground space based on the first water level change, the second water level change, and the maximum drainage flow rate. Further details regarding this aspect may be found in the related description below.

Step 250, in response to the accumulated water probability of at least one sub-region being greater than a probability threshold, determining a control time interval based on the personnel density and the personnel flow information, adjusting, at a control time point, an entrance gate of the underground space to a prohibited entry state, and control the current drainage device to perform drainage at a maximum power, the control time point being determined based on the control time interval.

The probability threshold refers to an upper limit of the water accumulation probability that triggers a risk response. When the water accumulation probability exceeds the probability threshold, risk response and emergency control measures are initiated immediately. The probability threshold may be preset by technical personnel. For example, the probability threshold may be set at 70%, 80%, 90%, etc.

The control time point refers to a time point at which emergency control measures are activated in response to a water accumulation risk. The control time interval refers to a time interval between the control time point and the current time. In some embodiments, the control time point is determined based on the control time interval. A time corresponding to a lapse of the control time interval from a current time is defined as the control time point. For example, when the control time interval is 0 min, the control time point is the current time. As another example, when the control time interval is 10 min, the control time point is a time 10 min after the current time.

There are two known scenarios: at least one sub-region having a water accumulation probability greater than the probability threshold, and at least one sub-region having a water accumulation probability not greater than the probability threshold. In some embodiments, in response to the water accumulation probability of at least one sub-region being greater than the probability threshold, the emergency supervision management platform may determine the control time interval in various ways based on the personnel density and the personnel flow information.

For example, the emergency supervision management platform may determine an average personnel density and an average personnel density change rate of the underground space by calculating an average of personnel densities of all sub-regions within the underground space and an average of personnel density change rates of all sub-regions, respectively. If the average personnel density change rate of the underground space is greater than or equal to 0, and the average personnel density of the underground space is greater than a preset density threshold, the emergency supervision management platform may set the control time interval to the current time. If the average personnel density change rate of the underground space is less than 0, and the average personnel density of the underground space is greater than the preset density threshold, the emergency supervision management platform may determine the control time interval based on the following formula (3):

$$T = \frac{Q - {Q}_{p}}{ρ} , \qquad ( 3 )$$

wherein, T denotes the control time interval, Q denotes the average personnel density of the underground space, Qₚ denotes the preset density threshold (preset by technical personnel), and ρ denotes the average personnel density change rate of the underground space.

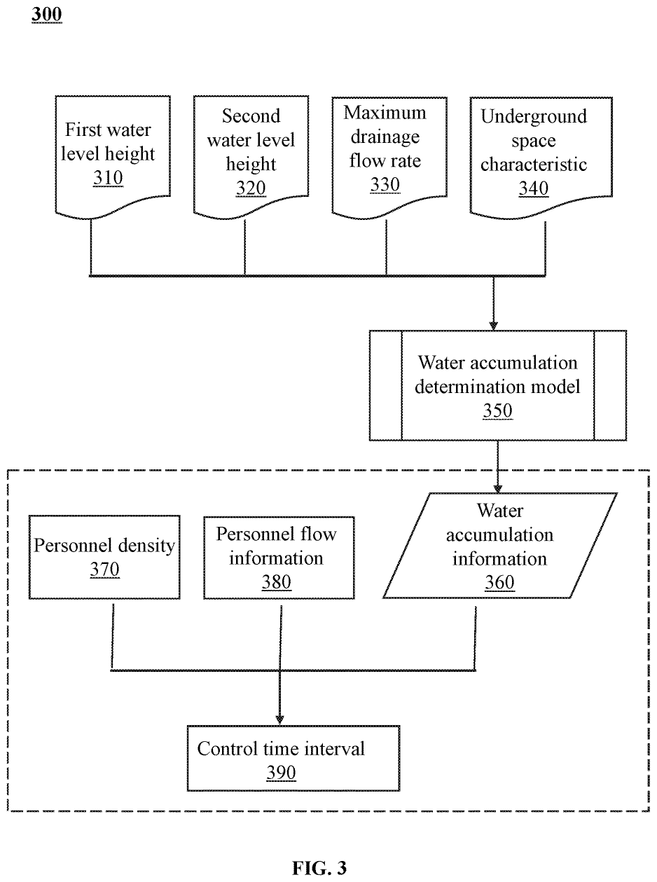

In some embodiments, the emergency supervision management platform may determine water accumulation information by using a water accumulation determination model based on the first water level height, the second water level height of the second drainage structure, the maximum drainage flow rate, and an underground space characteristic; and determine the control time interval based on the personnel density, the personnel flow information, and the water accumulation information. For details regarding this part, please refer to FIG. 3 and its related description in the present disclosure.

The entrance gate is located at an entrance of the underground space. Personnel may enter the underground space via the entrance gate. When the entrance gate is in the prohibited entry state, personnel cannot enter the underground space through the entrance gate but can exit the underground space unidirectionally.

The maximum power refers to a maximum drainage power at which the current drainage device operates for drainage tasks.

In some embodiments, the emergency supervision management platform may control the entrance gate of the underground space to switch to the prohibited entry state at the control time point and operate the current drainage device at the maximum power for drainage.

The embodiments of the present disclosure determine the control time interval based on the personnel density and the personnel flow information, which can improve the efficiency and accuracy of emergency response. By controlling the entrance gate of the underground space to switch to the prohibited entry state at the control time point and operating the current drainage device at the maximum power for drainage, more personnel can be prevented from entering the underground space before waterlogging occurs, and accumulated water can be discharged as quickly as possible to ensure personnel safety.

To more comprehensively and accurately predict the water accumulation probability in each sub-region of the underground space, water level conditions of other drainage structures within the underground space may be further considered.

Therefore, in some embodiments, the step of the emergency supervision management platform determining the water accumulation probability for each sub-region within the underground space based on the first water level change and the maximum drainage flow rate may further include: determining a second water level height and a second water level change of a second drainage structure based on water level measurement device; and determining the water accumulation probability for each sub-region within the underground space based on the first water level change, the second water level change, and the maximum drainage flow rate.

Correspondingly, the method for urban underground space emergency warning based on the IoT large model-based may further include: in response to the water accumulation probability of at least one sub-region being greater than the probability threshold, activating a backup drainage device, and controlling the current drainage device and the backup drainage device perform drainage at the maximum power.

The second drainage structure refers to one or more construction facilities installed at the entrance of the underground space, designed to intercept external water from flowing into the underground space. For example, the second drainage structure may include an interception trench located beneath entrance steps of the underground space. One or more interception trenches are mechanically connected to sump pits. Water level measurement device(s) may be deployed within the second drainage structure. For a detailed description of the water level measurement device, please refer to the earlier sections of the present disclosure.

Since the second drainage structure serves as the first line of defense against external water entering the underground space, the water level measurement device deployed within the second drainage structure can reflect a real-time situation of external water inflow (e.g., a flow rate of external water entering the underground space).

The second water level height refers to a water level height of the second drainage structure at the current time. In some embodiments, the water level measurement device deployed in the second drainage structure may directly monitor and obtain the second water level height and transmit the second water level height to the emergency supervision management platform via the emergency supervision sensor network platform.

The second water level change refers to a rate of change of the second water level height of the second drainage structure at the current time. The second water level change reflects a speed at which the second water level height of the second drainage structure is rising or falling at the current time. The second water level change may be expressed as an amount of change in the second water level height per unit time, where a positive value indicates that the second water level change is rising and a negative value indicates that the second water level change is falling.

In some embodiments, the emergency supervision management platform may perform curve fitting on the second water level heights corresponding to multiple time points within the current period and take a slope of a tangent line at the current time as the second water level change at the current time.

In some embodiments, the emergency supervision management platform may determine the water accumulation probability for each sub-region within the underground space in various ways based on the first water level change, the second water level change, and the maximum drainage flow rate.

For example, if the first water level change of a sump pit within the underground space is greater than 0, and the second water level changes of multiple interception trenches connected to the sump pit are all greater than 0, it indicates that a large amount of external water is rapidly flowing into the underground space (a rate of external water entering the interception trenches exceeds a rate at which the trenches drain into the connected sump pit). If a product of the first water level change of the sump pit and a bottom area of the sump pit is greater than the maximum drainage flow rate of all current drainage devices within the sump pit, it indicates that the water accumulation rate in the sump pit exceeds the drainage rate of the current drainage device. The emergency supervision management platform may then determine that the water accumulation probabilities for sub-regions adjacent to the sump pit are 1.

In some embodiments, the emergency supervision management platform may determine the water accumulation probabilities for sub-regions adjacent to a sump pit using formula (4), which can be expressed as follows:

$${y}_{2} = {y}_{1} * ( 1 + \frac{{v}_{2}}{h} ) * 100 \% , \qquad ( 4 )$$

wherein, y₁ denotes the water accumulation probability for each sub-region adjacent to the sump pit connected to multiple interception trenches, calculated via the aforementioned formula (2); v₂ denotes an average value of second water level changes of the multiple interception trenches connected to the sump pit; h denotes an average dimensional height of the multiple interception trenches connected to this sump pit (obtained based on GIS); and y₂ denotes a recalculated water accumulation probability for each sub-region adjacent to the sump pit connected to multiple interception trenches, after considering the water level conditions in the interception trenches. All values in formula (4) are dimensionless. If the calculated y₂ from formula (4) is greater than 1, the emergency supervision management platform may determine y₂ as 1.

As another example, if the first water level change of a sump pit within the underground space is greater than 0, but the second water level heights of the interception trenches connected to the sump pit are below the preset water level threshold and the second water level changes of the interception trenches connected to the sump pit equal 0, it indicates that the accumulated water in the sump pit does not originate from external sources (e.g., water level rise due to other factors such as internal pipe rupture). In this case, the emergency supervision management platform may predict the water accumulation probability by synthesizing other factors (for example, predicting the water accumulation probabilities for sub-regions adjacent to a ruptured internal pipe as 1, etc.).

The backup drainage device refers to a standby drainage device. When the current drainage device is insufficient to address waterlogging within the underground space, the backup drainage device is activated to enhance drainage capacity. For details regarding the working parameter of the backup drainage device, please refer to the earlier description of the working parameter of the current drainage device, which will not be reiterated here.

In some embodiments, in response to the water accumulation probability of at least one sub-region being greater than the probability threshold, the emergency supervision management platform may activate the backup drainage device, and control the current drainage device and the backup drainage device to perform drainage at the maximum power. For related descriptions of the probability threshold and the maximum power, please refer to the earlier sections of the present disclosure.

The embodiments of the present disclosure combine the first water level change of the first drainage structure and the second water level change of the second drainage structure, enabling more accurate identification of the source of waterlogging within the underground space and improving the reliability of emergency warnings. By activating the backup drainage device, the system can respond more proactively to waterlogging risks, thereby enhancing the overall capability to manage such risks within the underground space.

FIG. 3 is an exemplary schematic diagram illustrating the determination of a control time interval according to some embodiments of the present disclosure.

In some embodiments, as shown in FIG. 3, the emergency supervision management platform may determine water accumulation information 360 by using a water accumulation determination model 350, based on a first water level height 310, a second water level height 320 of a second drainage structure, a maximum drainage flow rate 330, and an underground space characteristic 340. The water accumulation determination model is a machine learning model. Subsequently, a control time interval 390 may be determined based on personnel density 370, personnel flow information 380, and the water accumulation information 360.

For related descriptions of the first water level height, the second drainage structure, the second water level height, the maximum drainage flow rate, the personnel density, the personnel flow information, and the control time interval, please refer to the relevant explanations above.

The underground space characteristic refers to relevant features reflecting an internal structure of the underground space. For example, the underground space characteristic may include spatial layouts, dimensional parameters, geographic parameters, etc., of various structures within the underground space.

In some embodiments, the emergency supervision management platform may obtain the underground space characteristic from a Geographic Information System (GIS) or other sources.

The water accumulation information refers to information related to future water accumulation conditions within the underground space. For example, the water accumulation information may include water-accumulated sub-region(s) and water accumulation time(s) corresponding to the water-accumulated sub-region(s). Here, a water-accumulated sub-region refers to a sub-region predicted to experience water accumulation. The water accumulation time corresponding to a water-accumulated sub-region refers to a future time when water accumulation begins in the sub-region (i.e., the future time when a ground water level height in the sub-region changes from 0 to non-zero), which may be expressed as a time difference from the current time. For example, 10 minutes after the current time.

In some embodiments, the emergency supervision management platform may determine the water accumulation information by using the water accumulation determination model, based on the first water level height, the second water level height, the maximum drainage flow rate, and the underground space characteristic.

The water accumulation determination model refers to a model configured to determine the water accumulation information. The water accumulation determination model may be a machine learning model. For example, the water accumulation determination model may include a Recurrent Neural Network (RNN) model.

In some embodiments, an input of the water accumulation determination model may include the first water level height of each of one or more sump pits, the second water level height of the second drainage structure, the maximum drainage flow rate of the current drainage device corresponding to each of the one or more sump pits, and the underground space characteristic. An output of the water accumulation determination model may be the water accumulation information.

The water accumulation determination model may be trained based on multiple sets of labeled training samples. The training samples and labels may be obtained from pre-stored historical data. The pre-stored historical data may include historical records of actual waterlogging incidents that occurred in historical underground spaces (the same underground space and/or other underground spaces).

By way of example, a set of training samples may include, for a historical waterlogging incident in a historical underground space: a historical first water level height of each of one or more sump pits within the historical underground space at a first historical time, a historical second water level height of a historical second drainage structure at the first historical time, a historical maximum drainage flow rate of a historical drainage device corresponding to each of the one or more sump pits at the first historical time, and the underground space characteristic of the historical underground space. A label corresponding to the set of training samples may be actual water accumulation information of the historical waterlogging incident in the historical underground space during a second historical period, including historically water-accumulated sub-region(s) that actually experienced water accumulation and an actual historical water accumulation time (expressed as a time relative to the first historical time) when each historically water-accumulated sub-region began to accumulate water. The first historical time is a specific historical time when no historical sub-region within the historical underground space had accumulated water. The second historical period is a future time period relative to the first historical time and occurs after the first historical time.

In some embodiments, the emergency supervision management platform may input multiple labeled training samples into an initial water accumulation determination model, construct a loss function using the labels and output results of the initial water accumulation determination model, and iteratively update parameters of the initial water accumulation determination model based on the loss function through gradient descent or other techniques. When a preset condition is met, the model training is completed, and a trained water accumulation determination model is obtained. The preset condition may include convergence of the loss function, a count of iterations reaching a threshold, etc.

In some embodiments, the emergency supervision management platform may determine the control time interval based on the personnel density, the personnel flow information, and the water accumulation information. For example, if a count of water-accumulated sub-regions is greater than a preset quantity threshold, an average personnel density of the underground space is greater than a preset density threshold, and an average personnel density change rate of the underground space is greater than or equal to 0, the emergency supervision management platform may determine the control time interval as 0 minutes, thereby setting the current time as the control time point. The preset quantity threshold is predefined by technical personnel. For related descriptions of the average personnel density of the underground space, the average personnel density change rate, the preset density threshold, etc., please refer to the description related to FIG. 2.

As another example, to obtain a more precise control time interval, the emergency supervision management platform may further consider the water accumulation information and determine the control time interval based on the following formula (5):

$${T}^{′} = a * \frac{{\sum }_{i = 1}^{n} ( {t}_{i} - t )}{n} + b * T , \qquad ( 5 )$$

wherein, T′ denotes the control time interval; tᵢ denotes ta water accumulation time of an i-th water-accumulated sub-region; n denotes the count of water-accumulated sub-regions; T denotes the control time interval determined based on the personnel density and the personnel flow information (e.g., the control time interval calculated by formula (3)); a denotes a weight value related to the water accumulation information; b denotes a weight value for the control time interval T determined based on the personnel density and the personnel flow information. Both a and b may be preset by technical personnel. For a detailed description of the control time interval T, please refer to the related description of FIG. 2 in the present disclosure.

In the embodiments of the present disclosure, the water accumulation determination model enables accurate prediction of future waterlogging incidents, providing more detailed and quantifiable water accumulation information. Based on the water accumulation information, a more precise control time interval can be determined, facilitating timely initiation of emergency measures, thereby improving the accuracy of warnings and ensures personnel safety.

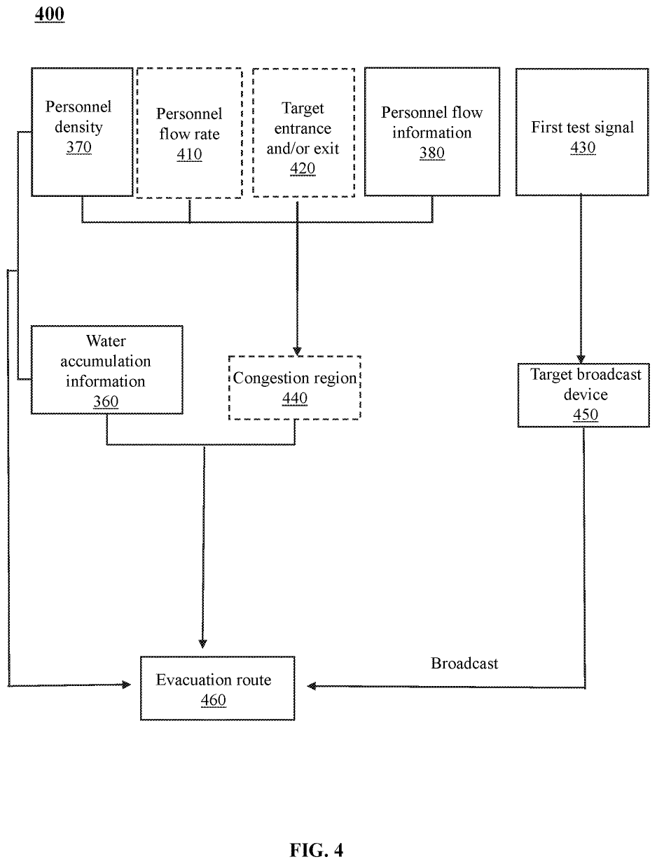

FIG. 4 is an exemplary schematic flowchart illustrating the broadcasting of an evacuation route according to some embodiments of the present disclosure.

In some embodiments, as shown in FIG. 4, the emergency supervision management platform may determine an evacuation route 460 based on water accumulation information 360 and a personnel density 370; determine a target broadcast device 450 based on a first test signal 430; and control the target broadcast device 450 to broadcast the evacuation route 460. For details regarding water accumulation information and the personnel density, please refer to the descriptions related to FIG. 2 and FIG. 3.

The evacuation route refers to a path guiding personnel to evacuate the underground space, for example, from a region A via a passageway 1 to a region D, and then through a passageway 3 to an exit C. The evacuation route must avoid water-accumulated sub-regions and high-density sub-regions, directing personnel to safe entrances and/or exits or safe sub-regions.

A high-density sub-region is a sub-region where the personnel density is greater than the preset density threshold. A safe sub-region refers to any sub-region other than a water-accumulated sub-region. A safe entrance and/or exit refers to an entrance and/or exit located within a safe region. For details regarding water-accumulated sub-regions and the preset density threshold, please refer to the description related to FIG. 3.

In some embodiments, the emergency supervision management platform may calculate one or more evacuation routes based on water accumulation information and personnel densities of sub-regions within the underground space using a path planning algorithm. The path planning algorithm may be an A* algorithm (also referred to as A-star search), a Dijkstra's algorithm, or the like.

For example, the emergency supervision management platform may abstract the underground space into a network graph structure using the path planning algorithm. The network graph consists of nodes and edges. By assigning dynamic weights to each edge, one or more evacuation routes can be calculated. The nodes represent various sub-regions within the underground space; nodes are connected by edges, which represent passageways connecting sub-regions corresponding to the nodes. The weight of an edge is positively correlated with water accumulation probabilities and personnel densities of the two nodes (two sub-regions) connected by the edge. The path planning algorithm tends to avoid edges with higher weights.

In some embodiments, as shown in FIG. 4, the emergency supervision management platform may determine a congestion region 440 based on a personnel flow rate 410, a target entrance and/or exit 420, the personnel density 370, and the personnel flow information 380. Subsequently, the emergency supervision management platform may determine the evacuation route 460 based on the water accumulation information 360 and the congestion region 440.

For details regarding the water accumulation information, the personnel flow information, and the personnel density, please refer to the relevant descriptions above.

The personnel flow rate refers to a count of people entering the underground space per unit of time.

In some embodiments, the emergency supervision management platform may determine the personnel flow rate using a sensing device deployed within the underground space.

The target entrance and/or exit refer to an entrance and/or exit of the underground space that can serve as evacuation points. For example, the aforementioned safe entrance and/or exit.

In some embodiments, target entrance and/or exit may also include entrances and/or exits where second drainage structures with a second water level height below a water level threshold are located.

The water level threshold refers to a critical safety water level value used to assess the risk of water accumulation. In some embodiments, the water level threshold may be preset manually, e.g., 5 cm.

For details regarding the second drainage structure and the second water level height, please refer to FIG. 2 and related descriptions.

By clarifying the selection criteria for the target entrance and/or exit, some embodiments of the present disclosure significantly enhance the intelligence, safety, and reliability of emergency evacuation.

The congestion region refers to one or more sub-regions within the underground space where personnel congestion occurs, for example, sub-region(s) where the personnel density is greater than the preset density threshold or where the personnel density change rate is greater than a preset change rate threshold.

In some embodiments, the emergency supervision management platform may determine the congestion region in various ways based on the personnel flow rate, the target entrance and/or exit, the personnel density, and the personnel flow information. For example, the congestion region may be determined using a preset algorithm, which may include the following steps:

Step 1, determining an estimated congestion value for each sub-region using formula (6), based on the personnel flow rate, the personnel density, and the personnel flow information of each sub-region, and the target entrance and/or exit:

$$c = \frac{f}{m * k} , \qquad ( 6 )$$

wherein, c represents the estimated congestion value; f represents an estimated personnel flow rate; m represents a maximum safe carrying capacity; and k represents a distance coefficient relative to the target entrance and/or exit, which may be determined by consulting a manually preset lookup table. The closer a sub-region is to the target entrance and/or exit, the stronger an attraction of the sub-region to personnel, and thus a higher estimated congestion value is obtained. A smaller value of the distance coefficient k corresponds to a shorter distance, wherein the value of k does not exceed 1. Data used in formula (6) are dimensionless.

The estimated congestion value is a numerical value indicating a congestion level of a sub-region at a future time. The estimated congestion value may be represented by a value between 0 and 1, where a higher value indicates a greater degree of congestion. The estimated personnel flow rate refers to a personnel flow rate at the future time and may be represented by an average of historical personnel flow rates a plurality of neighboring historical same times, wherein the neighboring historical same times refer to historical times that are the same as the future time and are close to the future time in a historical sense. For example, when the future time is 10:00, the plurality of neighboring historical same times may be 10:00 on each day within a most recent week. The maximum safe carrying capacity refers to a maximum count of people a sub-region can accommodate, which may be predetermined manually.

Step 2, determining a preset congestion threshold for each sub-region based on the estimated personnel flow rate of each sub-region.

The preset congestion threshold is a dynamic threshold used to determine whether a sub-region is at risk of congestion at a future time. For example, the emergency supervision management platform may determine the preset congestion threshold by consulting a preset table based on the estimated personnel flow rate. The estimated personnel flow rates at different future times may be the same or different. Therefore, the preset congestion threshold may have dynamic values. For a sub-region with a relatively high estimated personnel flow rate, the risk of congestion is greater; therefore, a relatively low preset congestion threshold needs to be set to enable more sensitive warnings. Conversely, for a sub-region with a relatively low estimated personnel flow rate, the congestion risk is smaller, and a relatively high preset congestion threshold may be set to avoid false alarms. In other words, the estimated personnel flow rate may be negatively correlated with the preset congestion threshold.

Step 3, for a given future time, if the estimated congestion value of a sub-region at the future time is greater than the preset congestion threshold, marking the sub-region as a congestion region for the future time.

For details regarding the personnel density, the personnel flow rate, the personnel flow information, and the target entrance and/or exit, please refer to the relevant descriptions above.

In some embodiments, the emergency supervision management platform may determine the evacuation route in various ways based on the water accumulation information and the congestion region. For example, the evacuation route may be determined using the aforementioned path planning algorithm. In this process, the weight of an edge is positively correlated with the water accumulation probability, the personnel density, and the congestion level of the two nodes (two sub-regions) connected by the edge. (If a sub-region is a congestion region, the congestion level of the sub-region is marked as 1; if not, the congestion level of the sub-region is marked as 0). For specific details on the water accumulation information and the path planning algorithm, please refer to the relevant descriptions above.

Some embodiments of the present disclosure dynamically identify the congestion region by comprehensively considering the personnel flow rate, the target entrance and/or exit, the personnel density, and the personnel flow information. By integrating the water accumulation information, optimal evacuation route(s) are generated. This approach significantly enhances the accuracy and real-time capability of path planning, effectively preventing personnel from entering high-risk or congested regions, thereby improving the safety and overall efficiency of the evacuation process.

The first test signal refers to an instruction signal used to detect whether the broadcast device within the underground space is functioning normally. For example, the first test signal may be a dedicated status query command preset manually for the broadcast device.

The broadcast device refers to a device that disseminates the evacuation route to personnel within the underground space. Exemplary broadcast devices may include a voice broadcast system, an information display screen, or the like.

In some embodiments, the emergency supervision management platform may send the first test signal to all broadcast devices within the underground space. Functioning broadcast device(s) may receive the first test signal and send a feedback signal to the emergency supervision management platform, indicating that the first test signal has been received.

The target broadcast device refers to a broadcast device within the underground space that is functioning normally.

In some embodiments, the emergency supervision management platform may identify a broadcast device capable of sending the aforementioned feedback signal as the target broadcast device. At least one target broadcast device may be determined.

In some embodiments, the emergency supervision management platform may control the target broadcast device to announce the evacuation route according to a broadcast parameter.

The broadcast parameter refers to an operating parameter of the target broadcast device. For example, the broadcast parameter may include a broadcast volume and a broadcast frequency.

In some embodiments, the emergency supervision management platform may determine a failed device within the underground space based on a third test signal; adjust the broadcast parameter of the target broadcast device based on the failed device; and control the target broadcast device to broadcast with the adjusted parameter.

The third test signal refers to an instruction signal used to detect whether any failed device exists among all devices within the underground space. In some embodiments, the third test signal may be a general status query command preset manually for all devices.

In some embodiments, the emergency supervision management platform may send the third test signal to all devices within the underground space. Functioning device(s) may receive the third test signal and send a feedback signal to the emergency supervision management platform, indicating that the third test signal has been received.

The failed device refers to a device among all devices within the underground space that has malfunctioned. Malfunctions may include, but are not limited to, hardware damage, power failure, etc.

In some embodiments, a device within the underground space that cannot send the aforementioned feedback signal may be determined as the failed device.

In some embodiments, the emergency supervision management platform may determine a predicted failed device based on the first water level change, the second water level change of the second drainage structure, the water accumulation information, and the underground space characteristic, and mark the predicted failed device as the failed device.

The predicted failed device refers to a device within the underground space that are likely to malfunction in the future. For example, the predicted failed device may include a device that may be submerged by water in the future.

In some embodiments, the emergency supervision management platform may determine the predicted failed device by searching a device database based on the first water level change, the second water level change of the second drainage structure, the water accumulation information, and the underground space characteristic. For example, a device at risk of being submerged by accumulated water may be identified as the predicted failed device.

The device database stores a plurality of matching vectors and corresponding associated devices, which may be established based on historical data. An associated device refers to a historical actual failed device under a corresponding matching vector. Each matching vector is constructed based on the first water level change and the second water level variation of an underground space corresponding to the associated device at a first historical time, the water accumulation information during a historical second period, and the underground space characteristic.

In some embodiments, the emergency supervision management platform may construct a retrieval vector based on the first water level change, the second water level change, the water accumulation information, and the underground space characteristic. The the emergency supervision management platform may identify N matching vectors in the device database whose similarity to the retrieval vector is greater than a similarity threshold and determine the associated device corresponding to the N matching vectors as the predicted failed device. The similarity may be represented by metrics such as cosine similarity, and the similarity threshold may be preset manually.

For details regarding the first water level change, the second drainage structure, the second water level change, and the water accumulation information, please refer to the descriptions related to FIG. 2 and FIG. 3.

Some embodiments of the present disclosure achieve the determination of the predicted failed device by comprehensively analyzing the first water level change, the second water level change, water accumulation information, and underground space characteristic. This equips the emergency supervision management platform with the capability to anticipate and prevent risks, thereby enhancing the reliability and robustness of the Internet-of-Things large model-based urban underground space emergency warning system.

When the failed device is identified within a sub-region, the emergency supervision management platform dynamically adjusts the broadcast parameter of the target broadcast device surrounding the failed device based on its impact on the broadcasting of the evacuation route, thereby compensating for a functional gap caused by the failed device. For example, if a speaker in a sub-region malfunctions and cannot broadcast, the emergency supervision management platform may increase a volume of a functioning speaker near the failed device to ensure the effectiveness of the broadcast.

In some embodiments, the emergency supervision management platform may control the target broadcast device to broadcast the evacuation route with the adjusted broadcast parameters.

Some embodiments of the present disclosure identify the failed device by sending the third test signal and dynamically adjust the broadcast parameter of target broadcast device accordingly. This effectively prevents information interruption due to device failure, ensures the continuous accessibility of evacuation instructions, and strengthens the emergency response capability of the system for urban underground space emergency warning based on the IoT large model under abnormal operating conditions.

Some embodiments of the present disclosure generate the optimal evacuation route by integrating the water accumulation information and the personnel density, and precisely locate a fully functional broadcast device using test signals for instruction dissemination. This ensures the accuracy and reliability of evacuation guidance, effectively directs personnel away from hazardous regions, and improves the efficiency and safety of emergency response.

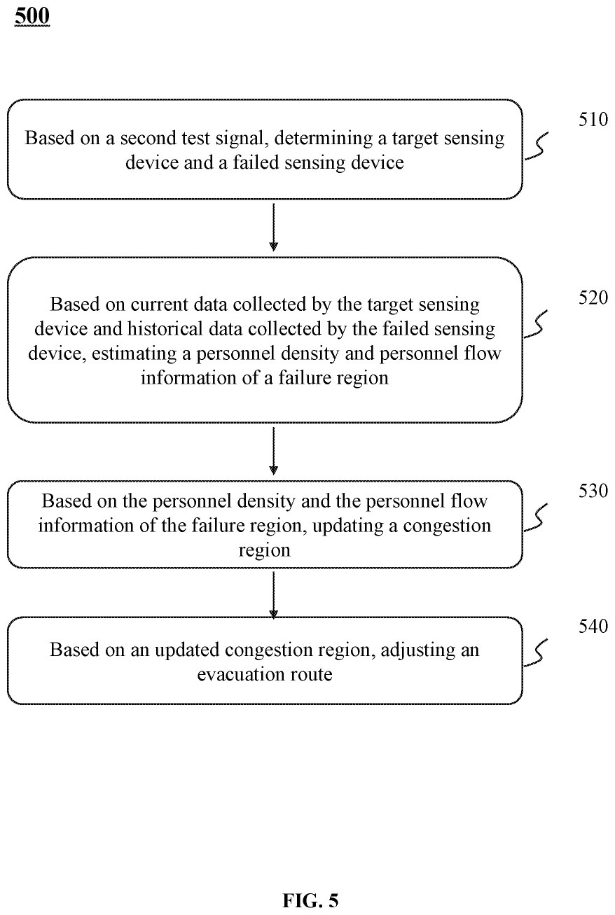

FIG. 5 is an exemplary flowchart illustrating the adjustment of an evacuation route according to some embodiments of the present disclosure. As shown in FIG. 5, a process 500 includes the following steps. In some embodiments, the process 500 may be executed by the emergency supervision management platform.

Step 510, determining a target sensing device and a failed sensing device based on a second test signal.

The second test signal refers to an instruction signal used to detect whether sensing devices within the underground space are functioning normally. In some embodiments, the second test signal may be a dedicated status query command for the sensing devices, preset manually.

In some embodiments, the emergency supervision management platform may send the second test signal to all sensing devices within the underground space. Functioning sensing device(s) may receive the second test signal and send a feedback signal to the emergency supervision management platform, indicating that the third test signal has been received.

The target sensing device refers to a sensing device within the underground space that is functioning normally.

In some embodiments, the emergency supervision management platform may determine a sensing device capable of sending the aforementioned feedback signal as the target sensing device. At least one target sensing device may be determined.

The failed sensing device refers to a sensing device within the underground space that has malfunctioned.

In some embodiments, a sensing device within the underground space that cannot send the aforementioned feedback signal may be determined as the failed sensing device.

Step 520, based on current data collected by the target sensing device and historical data collected by the failed sensing device, estimating a personnel density and personnel flow information of a failure region.

The current data refers to real-time data collected by the target sensing device, for example, personnel density and personnel flow information at a current time.

The historical data refers to data collected and stored by the failed sensing device at neighboring historical same times. Descriptions of the neighboring historical same times may be referred to in the foregoing related descriptions.

In some embodiments, the historical data may be retrieved by the emergency supervision management platform from a storage device.

The failure region refers to a sub-region where the personnel density and the personnel flow information cannot be obtained due to the malfunction of sensing devices.

In some embodiments, the emergency supervision management platform may determine a sub-region containing a failed sensing device as the failure region.

For details regarding the personnel density and the personnel flow information, please refer to FIG. 2 and the related description.

In some embodiments, the emergency supervision management platform may estimate the personnel density and the personnel flow information of the failure region by performing a weighted summation based on current data obtained from target sensing device(s) in adjacent sub-region(s) of the failure region and historical data collected by failed sensing device(s) within the failure region. For example, the emergency supervision management platform may perform a weighted summation on a personnel density of an adjacent sub-region 1 at a current time, a personnel density of an adjacent sub-region 2 at the current time, and a historical personnel density of the failure region. A result of the weighted summation is then determined as the personnel density of the failure region at the current time. Historical passenger flow rate may be represented by an average value of historical passenger flow rate s at a plurality of neighboring historical same times.

The weight of an adjacent sub-region may be positively correlated with a distance between the sub-region and the failure region, such such that an adjacent sub-region closer to the failure region is assigned a greater weight. A sum of weights corresponding to the current data of the adjacent sub-regions may be 0.5, while a weight corresponding to the historical data of the failure region may be 0.5.

Step 530, update a congestion region based on the personnel density and the personnel flow information of the failure region.

In some embodiments, the emergency supervision management platform may combine the current data collected by all target sensing devices with the estimated personnel density and personnel flow information of the failure region to obtain a comprehensive set of personnel density and personnel flow information of all sub-regions within the entire underground space. Based on the comprehensive information of all sub-regions, the congestion region is then re-determined. More descriptions regarding the congestion region and the process of determining the congestion region, please refer to the related description of FIG. 4 above, which will not be reiterated here.

Step 540, adjusting the evacuation route based on the updated congestion region.

In some embodiments, the emergency supervision management platform may dynamically adjust the evacuation route by re-invoking a path planning algorithm based on the re-determined congestion region, ensuring that the new evacuation route avoids the re-identified congestion region. For details regarding the path planning algorithm and the process of determining the evacuation route using the path planning algorithm, please refer to the description related to FIG. 4.

Some embodiments of the present disclosure identify the failed sensing device through the second test signal and perform joint estimation using the current data from the target sensing device combined with the historical data from the failed sensing device. This approach enables accurate inference of the personnel density and the personnel flow information in the failure region even when partial data is missing. Consequently, the congestion region can be dynamically updated and the evacuation route can be optimized, ensuring that emergency evacuation guidance remains reliable and effective despite anomalies in sensing devices, and improving adaptability of the system to device failures.

It should be noted that the descriptions of process 200 and process 500 above are provided for exemplary and illustrative purposes only and do not limit the applicable scope of the present disclosure. Those skilled in the art may make various modifications and changes to process 200 and process 500 under the guidance of the present disclosure. Such modifications and changes, however, shall remain within the scope of the present disclosure.

The basic concepts have been described above. Obviously, for those skilled in the art, the detailed disclosure above is merely illustrative and does not constitute a limitation on the present disclosure. Although not explicitly stated, those skilled in the art may make various modifications, improvements, and corrections to the present disclosure. Such modifications, improvements, and corrections are suggested within the present disclosure and thus remain within the spirit and scope of the exemplary embodiments of the present disclosure.

Meanwhile, the present disclosure uses specific terms to describe the embodiments herein. Terms such as “one embodiment,” “an embodiment,” and/or “some embodiments” mean that a certain feature, structure, or characteristic related to at least one embodiment of the present disclosure. Therefore, it is emphasized and noted that the terms “an embodiment,” “one embodiment,” or “an alternative embodiment” mentioned two or more times at different locations in the present disclosure do not necessarily refer to the same embodiment. Furthermore, certain features, structures, or characteristics in one or more embodiments of the present disclosure may be appropriately combined.

Furthermore, unless explicitly stated in the claims, the order of processing elements and sequences, the use of numbers or letters, or the use of other names in the present disclosure is not intended to limit the order of the processes and methods described herein. Although the foregoing disclosure discusses some currently considered useful inventive embodiments through various examples, it should be understood that such details are for illustrative purposes only, and the appended claims are not limited to the disclosed embodiments. On the contrary, the claims are intended to cover all modifications and equivalent combinations that conform to the essence and scope of the embodiments of the present disclosure. For example, although the system components described above may be implemented via hardware devices, they may also be realized solely through software solutions, such as installing the described system on existing servers or mobile devices.

Similarly, it should be noted that to simplify the presentation of the present disclosure and thereby aid in understanding one or more inventive embodiments, in the descriptions of the embodiments of the present disclosure above, various features may sometimes be grouped into a single embodiment, figure, or description thereof. However, this disclosure manner does not imply that the subject matter of the present disclosure requires more features than those mentioned in the claims. In fact, the features of an embodiment are fewer than all the features of a single embodiment disclosed above.

In some embodiments, numbers describing quantities or attributes are used. It should be understood that such numbers used in the description of the embodiments may, in some examples, be modified by the terms “approximately,” “about,” or “substantially.” Unless otherwise specified, “approximately,” “about,” or “substantially” indicates that the stated number allows for a variation of ±20%. Accordingly, in some embodiments, the numerical parameters used in the specification and claims are approximations, which may vary depending on the characteristics required by individual embodiments. In some embodiments, numerical parameters should consider the specified number of significant digits and adopt the method of general digit retention. Although the numerical ranges and parameters used to confirm their breadth in some embodiments of the present disclosure are approximations, in specific embodiments, such numerical values are set as accurately as possible within the feasible range.

For each patent, patent application, patent application publication, and other material, such as articles, books, specifications, publications, documents, etc., cited in the present disclosure, the entire content thereof is hereby incorporated by reference into the present disclosure. Excluded are application history documents that are inconsistent or conflict with the content of the present disclosure, and documents that limit the broadest scope of the claims of the present disclosure (whether currently or subsequently appended to the present disclosure). It should be noted that if the description, definition, and/or use of terms in the supplementary materials of the present disclosure are inconsistent or conflict with those in the present disclosure, the description, definition, and/or use of terms in the present disclosure shall prevail.

Finally, it should be understood that the embodiments described in the present disclosure are merely illustrative of the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to those explicitly introduced and described herein.

What is claimed is:

1. A system for urban underground space emergency warning based on an Internet of Things (IoT) large model, comprising an emergency supervision management platform; wherein
the emergency supervision management platform is configured to:
based on a working parameter of a current drainage device, determine a maximum drainage flow rate of the current drainage device;
based on a water level measurement device, determine a first water level height and a first water level change of a first drainage structure;
based on a sensing device, determine a personnel density and personnel flow information for each of one or more sub-regions within an underground space;
based on the first water level change and the maximum drainage flow rate, determine an accumulated water probability for each of the one or more sub-regions within the underground space; and
in response to the accumulated water probability of at least one sub-region being greater than a probability threshold, determine a control time interval based on the personnel density and the personnel flow information, adjust an entrance gate of the underground space to a prohibited entry state at a control time point, and control the current drainage device to perform drainage at a maximum power, the control time point being determined based on the control time interval.

2. The system according to claim 1, wherein the emergency supervision management platform is further configured to:
based on the water level measurement device, determine a second water level height and a second water level change of a second drainage structure;
based on the first water level change, the second water level change, and the maximum drainage flow rate, determine the accumulated water probability for each of the one or more sub-region within the underground space; and
in response to the accumulated water probability of the at least one sub-region being greater than the probability threshold, activate a backup drainage device, and control the current drainage device and the backup drainage device to perform drainage at the maximum power.

3. The system according to claim 1, wherein the emergency supervision management platform is further configured to:
based on the first water level height, a second water level height of a second drainage structure, the maximum drainage flow rate, and an underground space characteristic, determine water accumulation information through a water accumulation determination model, the water accumulation determination model being a machine learning model; and
based on the personnel density, the personnel flow information, and the water accumulation information, determine the control time interval.

4. The system according to claim 3, wherein the emergency supervision management platform is further configured to:
based on the water accumulation information and the personnel density, determine an evacuation route;
based on a first test signal, determine a target broadcast device; and
control the target broadcast device to broadcast the evacuation route.

5. The system according to claim 4, wherein the emergency supervision management platform is further configured to:
based on a personnel flow rate, a target entrance and/or exit, the personnel density, and the personnel flow information, determine a congestion region; and
based on the water accumulation information and the congestion region, determine the evacuation route.

6. The system according to claim 5, wherein the target entrance and/or exit includes an entrance at which the second drainage structure, whose second water level height is less than a water level threshold, is located.

7. The system according to claim 4, wherein the emergency supervision management platform is further configured to:
based on a second test signal, determine a target sensing device and a failed sensing device;
based on current data collected by the target sensing device and historical data collected by the failed sensing device, estimate a personnel density and personnel flow information of a failure region;
based on the personnel density and the personnel flow information of the failure region, update the congestion region; and
based on an updated congestion region, adjust the evacuation route.

8. The system according to claim 4, wherein the emergency supervision management platform is further configured to:
based on a third test signal, determine a failed device within the underground space; and
based on the failed device, adjust a broadcast parameter of the target broadcast device, and control the target broadcast device to broadcast with an adjusted broadcast parameter.

9. The system according to claim 8, wherein the emergency supervision management platform is further configured to:
based on the first water level change, a second water level change of the second drainage structure, the water accumulation information, and the underground space characteristic, determine a predicted failed device, and mark the predicted failed device as the failed device.

10. A method for urban underground space emergency warning based on an Internet of Things (IoT) large model, wherein the method is executed by an emergency supervision management platform in a system for urban underground space emergency warning based on the IoT large model, and the method comprises:
based on a working parameter of a current drainage device, determining a maximum drainage flow rate of the current drainage device;
based on a water level measurement device, determining a first water level height and a first water level change of a first drainage structure;
based on a sensing device, determining a personnel density and personnel flow information for each of one or more sub-regions within an underground space;
based on the first water level change and the maximum drainage flow rate, determining an accumulated water probability for each of the one or more sub-regions within the underground space; and
in response to the accumulated water probability of at least one sub-region being greater than a probability threshold, determining a control time interval based on the personnel density and the personnel flow information, adjusting an entrance gate of the underground space to a prohibited entry state at a control time point, and controlling the current drainage device to perform drainage at a maximum power, the control time point being determined based on the control time interval.

11. The method according to claim 10, wherein the based on the first water level change and the maximum drainage flow rate, determining an accumulated water probability for each of the one or more sub-regions within the underground space includes:
based on the water level measurement device, determining a second water level height and a second water level change of a second drainage structure; and
based on the first water level change, the second water level change, and the maximum drainage flow rate, determining the accumulated water probability for each of the one or more sub-regions within the underground space;
and the method further comprises:
in response to the accumulated water probability of at least one sub-regions being greater than the probability threshold, activating a backup drainage device, and controlling the current drainage device and the backup drainage device to perform drainage at the maximum power.

12. The method according to claim 10, wherein the determining a control time interval based on the personnel density and the personnel flow information includes:
based on the first water level height, a second water level height of a second drainage structure, the maximum drainage flow rate, and an underground space characteristic, determining water accumulation information through a water accumulation determination model, the water accumulation determination model being a machine learning model; and
based on the personnel density, the personnel flow information, and the water accumulation information, determining the control time interval.

13. The method according to claim 12, wherein the method further comprises:
based on the water accumulation information and the personnel density, determining an evacuation route;
based on a first test signal, determining a target broadcast device; and
controlling the target broadcast device to broadcast the evacuation route.

14. The method according to claim 13, wherein the based on the water accumulation information and the personnel density, determining an evacuation route includes:
based on a personnel flow rate, a target entrance and/or exit, the personnel density, and the personnel flow information, determining a congestion region; and
based on the water accumulation information and the congestion region, determining the evacuation route.

15. The method according to claim 14, wherein the target entrance and/or exit includes an entrance at which the second drainage structure, whose second water level height is less than a water level threshold, is located.

16. The method according to claim 13, wherein the method further comprises:
based on a second test signal, determining a target sensing device and a failed sensing device;
based on current data collected by the target sensing device and historical data collected by the failed sensing device, estimating a personnel density and personnel flow information of a failure region;
based on the personnel density and the personnel flow information of the failure region, updating the congestion region; and
based on an updated congestion region, adjusting the evacuation route.

17. The method according to claim 13, wherein the method further comprises:
based on a third test signal, determining a failed device within the underground space;
based on the failed device, adjusting a broadcast parameter of the target broadcast device, and controlling the target broadcast device to broadcast with an adjusted broadcast parameter.

18. The method according to claim 17, wherein the method further comprises:
based on the first water level change, a second water level change of the second drainage structure, the water accumulation information, and the underground space characteristic, determining a predicted failed device, and marking the predicted failed device as the failed device.

19. A non-transitory computer-readable storage medium, storing a computer instruction, wherein when a computer reads the computer instruction in the storage medium, the computer executes a method for urban underground space emergency warning based on an Internet of Things (IoT) large model, the method comprises:
based on a working parameter of a current drainage device, determining a maximum drainage flow rate of the current drainage device;
based on a water level measurement device, determining a first water level height and a first water level change of a first drainage structure;
based on a sensing device, determining a personnel density and personnel flow information for each of one or more sub-regions within an underground space;
based on the first water level change and the maximum drainage flow rate, determining an accumulated water probability for each of the one or more sub-regions within the underground space; and
in response to the accumulated water probability of at least one sub-region being greater than a probability threshold, determining a control time interval based on the personnel density and the personnel flow information, adjusting an entrance gate of the underground space to a prohibited entry state at a control time point, and controlling the current drainage device to perform drainage at a maximum power, the control time point being determined based on the control time interval.
